(19) United States
(12) Patent Application Publication
(10) Pub. No.: US 2008/0156799 A1
(43) Pub. Date: Jul. 3, 2008

(54) Yellow jacket trap decorative cover

(76) Inventor: Michael Parkey, Denver, CO (US)

Correspondence Address: Micheal Parkey, 1815 Grove St., Denver, CO, 80204, US

(21) Appl. No.: 12/005,599

(22) Filed: Dec. 28, 2007

Related U.S. Application Data
(60) Provisional application No. 60/877,281, filed on Dec. 28, 2006.
(60) Provisional application No. 60/879,492, filed on Jan. 9, 2007.
(60) Provisional application No. 60/878,993, filed on Jan. 8, 2007.

(51) Int. Cl. B65D 25/20; A01M 1/10; B65D 25/00

(52) U.S. Cl. 220/23.91; 43/122; 220/694

(57) ABSTRACT

A yellow jacket trap is enclosed in a decorative sleeve. The sleeve is made of plastic or a like material and is in the form of a cylinder. The decorative sleeve lends itself readily to changes in graphics. Thus, the sleeve covers the traps contents while providing a pleasing exterior. The exterior graphics are adaptable to any variety of outdoor settings.

### CROSS-REFERENCE TO RELATED APPLICATIONS

This application claims the benefit of provisional patent application Ser. No. 60/877,281 filed 2006 Dec. 28. Provisional patent Ser. No. 60/879,492 filed 2007 Jan. 9. Provisional Patent Ser. No. 60/878,993 filed 2007 Jan. 8. Provisional patent Ser. No. 60/900,215 filed 2007 Feb. 9. All were filed by present inventor.

### FEDERALLY SPONSORED RESEARCH

Not Applicable

### SEQUENCE LISTING OR PROGRAM

Not Applicable

### BACKGROUND OF THE INVENTION

1. Field of the Invention

The present invention pertains to the field of yellow jacket traps. More particularly, the inventions pertains to a yellow jacket trap having a decorative cover. The purpose of the yellow jacket trap cover is to provide an appealing, decorative covering to hide the dead insects contained inside the trap.

2. Description of Related Art

A yellow jacket trap has a cylindrical upper member detachably connected to a lower member. The upper member defines a hollow entrapment chamber having a bottom open end and a top end. The trap further includes an inverted cone which is removable and inserted within the cylindrical upper member. Refer to U.S. Pat. No. 5,557,880. The problem with this device is it works almost to well. The transparent and hollow entrapment chamber fills up with dead yellow jackets; thus, making the trap when placed in plain view very unsightly.

### SUMMARY OF THE INVENTION

The present invention pertains to a yellow jacket trap which the exterior appearance may be easily and inexpensively changed to match said traps surroundings while hiding its contents. The yellow jacket trap of the subject invention is comprised of an upper member with a hollow entrapment chamber. The said entrapment chamber is encased or covered by a decorative plastic sleeve having an overall length which is equal too or a substantial fraction of the overall chamber length. Also, in cross section comprises a cylinder or coil whose mean diameter is slightly larger or equal to the exterior diameter of said entrapment chamber. The decorative sleeve is removable and can be easily mounted onto the linear portion of the entrapment chamber.

### BRIEF DESCRIPTION OF THE DRAWINGS

FIG. 1 is a drawing of the trap cover. A sleeve with a cylindrical cross-section.

FIG. 2 Bottom view of the trap cover. Showing it is hollow and cylindrical in shape.

FIG. 3 Shows another embodiment of the trap cover with a sight bar. Allowing the contents of said entrapment chamber to be viewed.

FIG. 4 Shows another embodiment of the of the trap cover in which the sides are tapered allowing the cover to fit snug and exact along the exterior of the entrapment chamber.

FIG. 5 Shows a flat sheet of thin plastic or weather proof paper. Which has been cut to have hooks on one end and slits on the other end of said sheet. Creating a tongue and groove which at current state is a “non-closed cylinder.”

FIG. 6 Demonstrates how the “non-closed” sheet can be easily folded inward on itself and held intact by inserting the tongue appendages into the “groove” or “slits” Creating a cylinder.

FIG. 7 Shows how the trap cover is easily slid or mounted into place over the entrapment chamber of said trap.

FIG. 8 Shows the cover resting snug over the entrapment chamber concealing any contents which may be within said trap.

### DESCRIPTION OF THE PREFERRED EMBODIMENTS

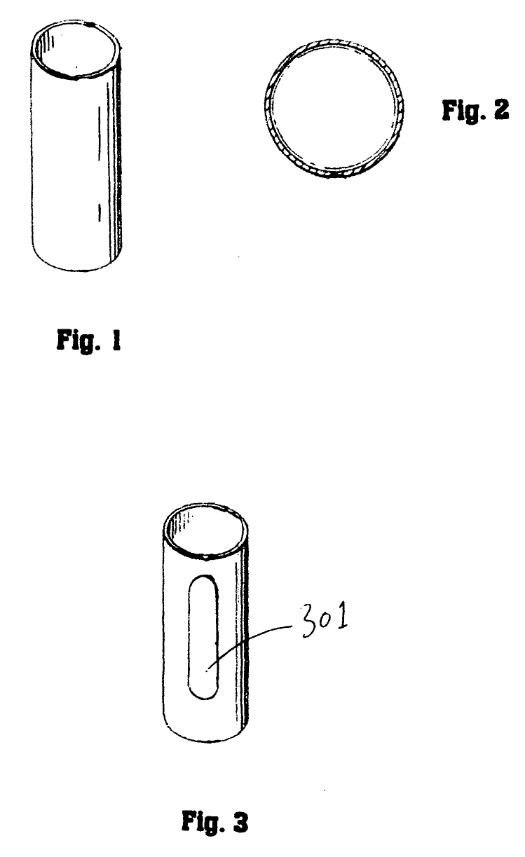

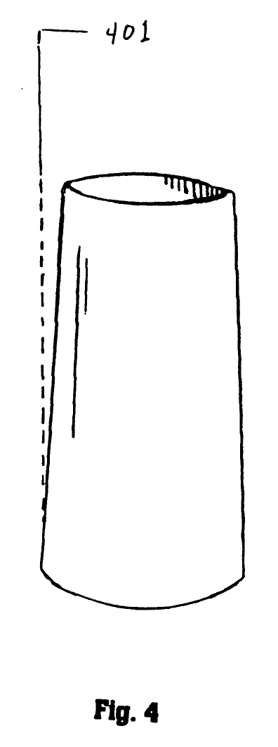

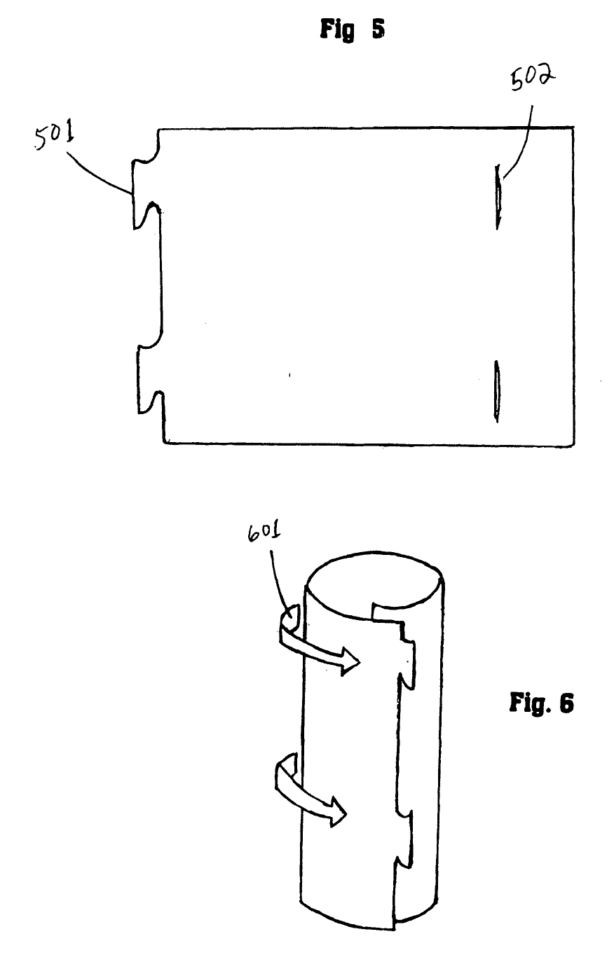

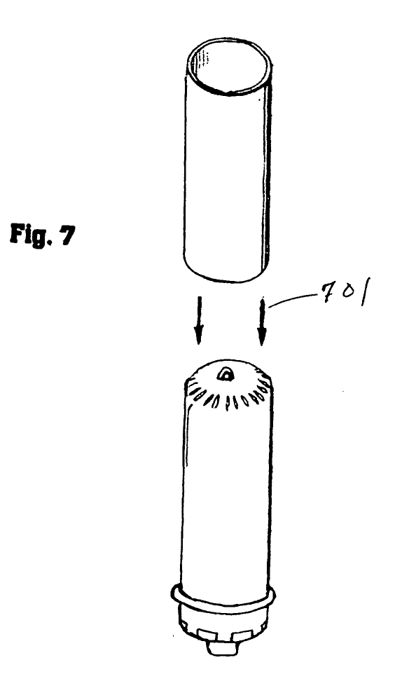

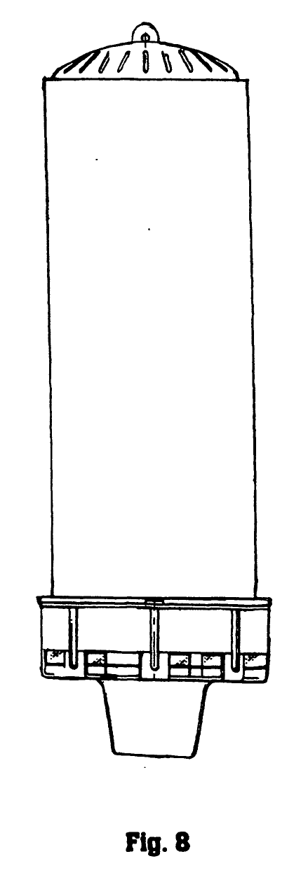

The decorative sleeve may be further described in relation to (FIG. 1) and (FIG. 2) which are self explanatory. In use the sleeve is slipped over the linear portion of the entrapment chamber (FIG. 7). The inner circumference of the sleeve should be equal to or slightly greater than the circumference of the entrapment chamber exterior. This will ensure that the sleeve fit snugly against the linear portion of the chamber. A sight bar (301) or section may be added to allow the user to view the contents of the entrapment chamber without removing the decorative cover.

By the term “substantially linear portion extending for a substantial fraction of the total length of the entrapment chamber” is meant a portion of the entrapment chamber having an inconsistent diameter or taper (401) extending over a length which is at least a substantial fraction of the overall chamber length. i.e. 60 percent or more, preferably 75 percent or more of the overall chamber length. The plastic sleeve is mounted to the entrapment chamber (701) by virtue of the mean inside diameter of the sleeve being substantially equal to the outside diameter of the entrapment chamber. The sleeve is easily removable and replaceable by hand, without the use of tools or other equipment.

The sleeve length is greater than 50 percent of the length of the linear portion of the entrapment chamber. Preferably 75 percent or greater and most preferably substantially the same length as that of the length of the linear portion of the entrapment chamber.

By the term “non-closed cylinder” is meant that the material being used is flat and has been cut to have hooks on one end (501) and slits (502) on the other end of said sheet. Creating a “tongue and groove”. The sheet is then formed or molded by attaching said sheet to itself (601) becoming an actual cylinder (601). By the term “resilient plastic” is meant a polymeric material which has sufficient resilience to withstand exterior conditions without permanently deforming.

The trap cover itself may taper or be slightly cone shaped (401) to insure a snug or uniform fit of the entrapment chamber. Preferably the decorative cover is made of plastic or nylon. However, other materials such as polyesters polypropylenes, polyacrylates and a series of modern weather resistant papers and the like can also be used. As the decorative covers are relatively inexpensive they may be conveniently manufactured somewhat larger than will ordinarily be necessary and cut to proper length and dimensions. The manufacture of such sleeves is well known to those skilled in the art of plastics fabricating and excursion and thus need not be described further.

What is claimed is:

1. A decorative covering or “sleeve” for the described yellow jacket trap.

2. The device of claim one is cylindrical in shape.

3. The device of claim one is hollow allowing it to be easily removed and attached without the use of tools or equipment.

4. The device of claim one has an inner circumference which is greater than or equal to the outer diameter of the said entrapment chamber.

5. The device of claim one may be tapered or cone shaped to fit snug to exterior dimensions of said entrapment chamber.

6. The device of claim one may have a sight-bar or hole by which the contents of said entrapment chamber may be viewed.

7. The device of claim one has a length greater than 50 percent of the linear portion of the entrapment chamber. Preferably greater than 75 percent and most preferably the same length of the linear portion of said entrapment chamber.

8. The device of claim one may, previous to assemblage, resemble a flat sheet which can be folded and attached onto itself by means of fasteners, adhesive or design to create a cylindrical shape.

9. The device of claim 8, wherein said sheet further comprises an adhesive for bonding with said traps components.

10. The device of claim one may be made from resilient plastic or other materials including nylon, polyesters, polystyrene, polypropylenes, polyacrylates and weather resistant papers.
